(19) United States
(12) Patent Application Publication
(10) Pub. No.: US 2004/0094252 A1
(43) Pub. Date: May 20, 2004

(54) Process for manufacturing, moulding and curing tyres for vehicles wheels

(76) Inventors: Maurizio Galimberti, Milano (IT); Luigi Fino, Bovisio Masciago (IT); Daniela Senatore, Norcera Superiore (IT); Enrico Albizzati, Lesa (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/433,894

(22) PCT Filed: Nov. 27, 2001
(86) PCT No.: PCT/EP01/13772

(30) Foreign Application Priority Data
Dec. 6, 2000 (EP) 00126779.8

(51) Int. Cl. B60C 5/14

(52) U.S. Cl. 152/510; 156/123

(57) ABSTRACT

A tyre for a vehicle wheel includes a carcass structure, a pair of inextensible annular structures, a belt structure, a tread band, a pair of sidewalls, and at least one coating layer. The carcass structure includes at least one carcass ply shaped in a substantially-toroidal configuration and is engaged, by opposite circumferential edges, to the inextensible annular structures. The belt structure includes at least one belt strip applied in a circumferentially-external position relative to the carcass structure. The tread band is circumferentially superimposed on the belt structure. The sidewalls are applied to opposite sides of the carcass structure. The at least one coating layer includes crosslinked elastomeric material placed in a radially-internal position relative to the at least one carcass ply. The at least one coating layer is obtained by crosslinking at least one elastomer comprising hydrolyzable silane groups. A related process for producing the tyre is also disclosed.

The present invention relates to a process for manufacturing, moulding and curing tyres for vehicle wheels.

More particularly, the present invention relates to a process for manufacturing, moulding and curing tyres for vehicle wheels, which involves the introduction of a fluid under pressure directly in contact with the green tyre, that is to say in the absence of a vulcanization bladder.

In a cycle for vehicle wheels tyre production it is provided that, subsequently to a manufacturing process in which the various components of the tyre are made and assembled, a moulding and curing process intended to stabilize the structure of the tyre in a desired geometrical configuration, normally characterized by a particular tread pattern, is carried out. For this purpose, the green tyre is enclosed in a moulding cavity defined within a vulcanization mould and shaped according to the configuration of the outer surface of the tyre to be obtained.

For the purpose of the present invention and the claims, the term “green tyre” means the product obtained after the manufacturing step, in which are assembled the various components of the tyre and the elastomeric material is not yet vulcanized. The term “outer surface” means the visible surface of the tyre once this tyre has been mounted on the rim of the wheel, while the term “inner surface” means the surface of the tyre which is in contact with the fluid for inflating the tyre.

Curing methods are known in which steam or another fluid under pressure is introduced directly into the tyre enclosed in the moulding cavity, in the absence of a curing bladder. However, said methods, in which there is direct contact between the green tyre and the fluid under pressure, can lead to numerous drawbacks owing to the permeation of the fluid itself into the structure of the tyre which has not yet been vulcanized.

A number of solutions have been proposed in order to overcome the abovementioned drawbacks.

For example, German patent DE 355 909 discloses a process for manufacturing tyres in which a liquid under pressure is placed directly in contact with the inner surface of the tyre before or during vulcanization, characterized in that, before vulcanization, an inner layer of the tyre is treated so that it becomes impermeable to said liquid. Said treatment is carried out by partial vulcanization of the layer(s) which form(s) the abovementioned inner layer, before or after the other layers which form the tyre are superimposed. The elastomeric composition of said inner layer is not described.

Patent U.S. Pat. No. 2,795,262 discloses a method for preparing a tyre carcass which involves applying to the inner surface of said non-vulcanized carcass a continuous film based on an elastomeric silicone polymer so as to prevent direct contact of the fluid under pressure with the carcass which has not yet been vulcanized.

British patent GB-A-0 397 508 discloses a method for producing tyres in which a coating is applied to the inner surface of the green tyre by spraying, this coating comprising an adhesive or gelatin, glycerol or polyglycerol, water, phenol and alcohol so as to prevent direct contact of the fluid under pressure with the carcass.

Patent U.S. Pat. No. 3,769,122 discloses a method for preparing the innerliner of a tubeless tyre, which involves applying an elastomeric material to the inner surface of the carcass of said tyre, by spraying, this elastomeric material essentially comprising 85%-100%, preferably 95%-100%, even more preferably 100%, of a halobutyl or butyl rubber or mixtures thereof. Said application can be carried out before or after moulding and curing the tyre and the elastomeric material applied is then cured at ambient temperature or at moderately elevated temperatures. For the purpose of increasing the rate of curing, an ultra-accelerator such as, for example, para-quinone dioxime is added. If the application takes place before the curing of the tyre, the curing, total or partial, of said innerliner would make it possible to obtain a barrier to the fluid under pressure, so as to prevent direct contact of this fluid under pressure with the carcass.

Patent U.S. Pat. No. 4,221,253 discloses a process for producing tyres in which the inner surface of the tyre is partially or totally vulcanized by irradiation with electrons. Said treatment would make it possible to obtain a barrier to the fluid under pressure, so as to prevent direct contact of this fluid under pressure with the carcass.

European patent application EP-A-0 976 534 in the name of the Applicant discloses a process for manufacturing a tyre which includes a step of treating the inner surface of the green tyre so as to prevent the permeation of the fluid under pressure into the structure of the tyre: said treatment may be carried out by combining at least one layer made of prevulcanized elastomeric material with the inner surface of the green tyre. For the purpose of increasing the rate of vulcanization and/or reducing the temperature required to obtain a sufficient degree of pre-vulcanization, a nitrogen-containing co-accelerator chosen, for example, from: N-cyclohexyl-N-ethylamine, diphenylguanidine and the like, may be advantageously added to the vulcanization accelerators normally used, in an amount of between 2 phr and 15 phr, preferably between 5 phr and 10 phr.

The Applicant has found that the most critical step, with regard to the diffusion of the fluid under pressure into the structure of the tyre which has not yet been vulcanized, is that corresponding to the initial moments of the introduction of said fluid under pressure directly into the tyre enclosed in the moulding cavity, that is to say when the degree of crosslinking of the elastomeric material of which the tyre is made is substantially zero or at any rate very low. As a matter of fact, the permeation of the fluid under pressure may lead, for example, to delamination between the adjacent blend layers, may have a negative impact on the adhesion processes between the elastomeric material and the metallic or textile reinforcing structures, or may even promote corrosion of the metallic reinforcing materials.

The Applicant has now found that it is possible to overcome the abovementioned drawbacks by producing a layer of elastomeric material which is capable of reaching, in the early stages of the manufacturing of the tyre, in particular in the initial moulding stage when the fluid under pressure is introduced into the tyre which has not yet been vulcanized, a degree of crosslinking which is sufficient to contain said fluid under pressure.

The Applicant has found that it is possible to satisfy the abovementioned requirements by producing a layer of crosslinkable elastomeric material comprising at least one elastomer containing hydrolysable silane groups. The presence of said hydrolysable silane groups is capable of increasing the rate of crosslinking of said elastomeric material and thus makes it possible to avoid the use of co-accelerators or of large amounts of vulcanization accelerators, and to avoid special treatments of the inner surface of the tyre.

According to a first aspect, the present invention relates to a process for manufacturing, moulding and curing tyres for vehicle wheels, comprising the following steps:

forming at least one coating layer made of crosslinkable elastomeric material on an outer surface of a toroidal support the shape of which substantially matches that of the inner surface of the tyre;

manufacturing a green tyre comprising at least one element which includes a crosslinkable elastomeric material on said toroidal support bearing said coating layer;

closing the green tyre in a moulding cavity defined inside a vulcanization mould, said moulding cavity having walls the shape of which matches that of an outer surface of the tyre once vulcanization is complete;

introducing into the space defined by an inner surface of the tyre a fluid under pressure to press the outer surface of the green tyre against the walls of the moulding cavity;

applying heat to the tyre for causing the vulcanization of the crosslinkable elastomeric material;

characterized in that said coating layer comprises at least one elastomer containing hydrolysable silane groups.

Said coating layer also preferably comprises a crosslinking agent based on sulphur or derivatives thereof.

According to a preferred embodiment, said coating layer reaches a degree of crosslinking which is sufficient to prevent the diffusion and penetration of the fluid under pressure into the green tyre, within a period not greater than 10 minutes, preferably between 1 minute and 5 minutes, working at a temperature not greater than 210° C., preferably between 100° C. and 140° C.

According to a preferred embodiment, said fluid under pressure is chosen from steam, air and nitrogen, or mixtures thereof. More preferably, said fluid under pressure is steam.

In a second aspect, the present invention relates to a tyre for vehicle wheel, comprising the following elements:

a carcass structure having at least one rubberized carcass ply shaped in a substantially toroidal configuration and engaged, by means of its opposite circumferential edges, to a pair of inextensible annular structures;

a belt structure comprising at least one belt strip applied in a circumferentially external position relative to said carcass structure;

a tread band circumferentially superimposed on said belt structure;

a pair of sidewalls applied laterally to opposite sides relative to said carcass structure;

a coating layer made of crosslinked elastomeric material placed in a radially internal position relative to said rubberized carcass ply;

characterized in that said coating layer is obtained by crosslinking at least one elastomer containing hydrolysable silane groups. Preferably, the crosslinking of said coating layer is obtained in the presence of a crosslinking agent based on sulphur or derivatives thereof.

According to a preferred embodiment, said coating layer is impermeable to a fluid for inflating the tyre when the tyre is installed on a rim and inflated. In other words, this layer is capable of acting as the so-called liner which, in tubeless tyres, is the air-impermeable layer which ensures the hermetic seal of the tyre when this tyre is installed on a rim and inflated.

According to a preferred embodiment, said coating layer comprises from 20 phr to 100 phr, preferably from 50 phr to 90 phr, of at least one elastomer containing hydrolysable silane groups. Said elastomer preferably comprises from 0.1% to 5% by weight, more preferably from 0.5% to 3% by. weight, of hydrolysable silane groups.

For the purpose of the present description and the claims which follow, the term “phr” is used to indicate the parts by weight of a given ingredient per each 100 parts by weight of the elastomeric base.

According to another preferred embodiment, said coating layer also comprises from 0 phr to 30 phr, preferably from 5 to 15 phr, of at least one butyl rubber.

According to a further preferred embodiment, said coating layer also comprises from 0 phr to 80 phr, preferably from 10 phr to 50 phr, of at least one diene elastomer other than butyl rubber.

According to another preferred embodiment, said coating layer also comprises from 0 phr to 3 phr, preferably from 0.5 phr to 1.5 phr, of a coupling agent.

According to another preferred embodiment, said coating layer also comprises from 0 phr to 0.5 phr, preferably from 0.05 phr to 0.15 phr, of a condensation catalyst.

According to another preferred embodiment, said coating layer also comprises from 0 phr to 5 phr, preferably from 0.5 phr to 3 phr, of a silane of general formula (I):

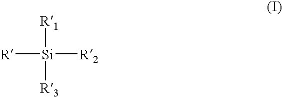

in which:

R′ is chosen from C₁-C₁₈ alkyl groups, C₆-C₂₀ aryl groups, C₇-C₃₀ alkylaryl or arylalkyl groups, C₃-C₃₀ cycloalkyl groups, said cycloalkyl groups optionally being substituted with C₁-C₁₈ alkyl groups;

R′₁, R′₂ and R′₃, which may be identical or different, are chosen from hydrogen, C₁-C₈ alkoxy groups, C₁-C₁₈ alkyl groups, C₆-C₂₀ aryl groups, C₇-C₃₀ alkylaryl or arylalkyl groups, on condition that at least one of the groups R′₁, R′₂ and R′₃ represents an alkoxy group.

According to a particularly preferred embodiment, the abovementioned elastomer containing hydrolysable silane groups may be obtained by reacting an elastomer containing at least one functional group with a silane containing at least one hydrolysable group and at least one reactive group which is capable of reacting with said functional group of the elastomer.

Preferably, the elastomer containing hydrolysable silane groups may be obtained by reacting an elastomer containing at least one halogen functional group chosen from chlorine and bromine, with a silane containing at least one hydrolysable group and at least one reactive group which is capable of reacting with said functional group of the elastomer.

Alternatively, the elastomer containing hydrolysable silane groups may be obtained by reaction between an elastomer containing at least one functional group chosen from:

anhydride groups —(RCO)₂O in which R is an alkylene group;

carboxyl groups —COOH;

ester groups —COOR in which R is an alkyl or aryl group;

amide groups —CONH₂;

with a silane containing at least one hydrolysable group and at least one reactive group which is capable of reacting with said functional group of the elastomer.

The reactive group of the silane is preferably chosen from amine groups and epoxide groups.

According to a preferred embodiment, said silane is used in an amount comprised between 0.1 phr and 5 phr, preferably between 0.5 phr and 3 phr.

When the elastomer contains at least one halogen functional group, said coating layer also comprises from 0.1 phr to 4 phr, preferably from 1 phr to 3 phr, of a trapping agent.

The elastomer containing hydrolysable silane groups is advantageously prepared “in situ” at the time of preparation of the compound used for said coating layer, in particular during the first step of processing of said compound as described below.

The process for producing the tyre according to the present invention may be carried out as disclosed, for example, in European patent applications EP-A-0 943 421 and EP-A-0 919 406 in the name of the Applicant, which are incorporated herein by means of reference. In particular, the tyre under consideration may be obtained by producing the various components directly on a toroidal support on which the tyre itself is formed step by step, or at least in the immediate vicinity of this tyre. It is also possible to produce said tyre according to conventional processes involving the steps of first preparing, separately, a series of semifinished articles corresponding to the various parts of the tyre (carcass plies, belt strips, bead wires, beads, fillers, sidewalls and tread bands) which are then combined together using a suitable manufacturing machine.

The green tyre obtained by one of the abovementioned processes is then subjected to a vulcanization step which may be carried out in any known conventional manner.

As mentioned above, the elastomer containing hydrolysable silane groups may be obtained from an elastomer containing a halogen functional group. Said elastomer may be chosen from halobutyl rubbers, epihalohydrin rubbers and halogenated isobutylene/p-alkylstyrene copolymers.

Halobutyl rubbers are derived from butyl rubbers by reaction of chlorine or bromine according to methods known in the art, and can contain up to 2 halogen atoms for each double bond present in the copolymer. Generally, halobutyl rubbers contain at least 0.5% by weight and preferably at least 1% by weight of halogen and have a viscosimetric average molecular weight comprised between 150,000 and 1,500,000 and a molar unsaturation comprised between 0.5% and 15%. Examples of butyl rubbers include copolymers containing from about 95.5% to about 99.5% of isobutylene and from about 0.5% to about 4.5% of isoprene.

Butyl rubbers that are particularly preferred according to the present invention are chlorobutyl rubber and bromobutyl rubber. Examples of commercially available chlorobutyl and bromobutyl rubbers which may be used in the present invention are the products Polysar® Chlorobutyl 1240 and Polysar® Bromobutyl 2030 from Bayer.

Epihalohydrin rubbers comprise (1) homopolymers of an epihalohydrin such as, for example, epichlorohydrin or epibromohydrin, and the like, (2) copolymers of an epihalohydrin with less than 30% of a saturated epoxide monomer or with an unsaturated epoxide monomer, and (3) terpolymers of an epihalohydrin with (a) less than 30% of a saturated epoxide monomer or mixtures of saturated epoxide monomers, (b) an unsaturated epoxide monomer or mixtures of unsaturated epoxide monomers, or with (c) mixtures of (a) and (b). The epihalohydrin polymers may be prepared by polymerizing an epihalohydrin monomer, alone or together with one or more of the epoxide monomers mentioned above, in the presence of a catalyst such as, for example, an organometallic catalyst. The epihalohydrin homopolymers are believed to contain repeating units of the following formula:

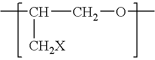

in which X is a halogen, derived from the polymerization which involves the epoxide bonds. The halogen is chosen from chlorine and bromine. The saturated epoxide monomers are chosen from alkylene oxides (for example ethylene oxide); the unsaturated epoxide monomer is, for example, allylglycidyl ether.

Further details regarding the preparation of the epihalohydrin polymers that are suitable for carrying out the present invention are disclosed, for example, in patent U.S. Pat. No. 3,158,500.

An example of an epihalohydrin rubber which may be used in the present invention and which is currently commercially. available is the product Hydrin® T75 from Nippon Zeon.

The halogenated isobutylene/p-alkylstyrene copolymers are chosen from copolymers of an isoolefin containing from 4 to 7 carbon atoms such as, for example, isobutylene, and of a p-alkylstyrene such as, for example, p-methylstyrene, are known in the prior art and are disclosed, for example, in patent U.S. Pat. No. 5,162,445.

Preferred products are those derived from the halogenation of a copolymer between an isoolefin containing from 4 to 7 carbon atoms such as, for example, isobutylene, and a comonomer such as p-alkylstyrene in which at least one of the substituents on the alkyl groups present in the styrene unit is a halogen.

Further details regarding the preparation of halogenated isobutylene/p-alkylstyrene copolymers that are suitable for carrying out the present invention are disclosed, for example, in patent U.S. Pat. No. 5,512,638.

Examples of halogenated isobutylene/p-alkylstyrene copolymers which may be used in the present invention and which are currently commercially available include the Exxpro® products from Exxon.

Alternatively, as mentioned above, the elastomer containing hydrolysable silane groups may be obtained from an elastomer containing a functional group chosen from anhydride groups, carboxyl groups, ester groups and amide groups. Said elastomer may be prepared as disclosed, for example, in patents U.S. Pat. No. 4,996,262 and U.S. Pat. No. 6,009,923.

According to a preferred embodiment, the silane containing at least one hydrolysable group and at least one reactive group which is capable of reacting with said functional group of the elastomer is an aminosilane of general formula (II):

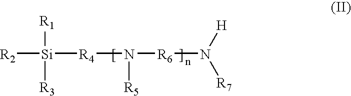

in which:

R₁, R₂ and R₃, which may be identical or different, are chosen from hydrogen, C₁-C₈ alkoxy groups, C₁-C₁₈ alkyl groups, C₆-C₂₀ aryl groups, C₇-C₃₀ alkylaryl or arylalkyl groups, on condition that at least one of the groups R₁, R₂ and R₃ represents an alkoxy group;

R₄ is chosen from C₁-C₁₈ alkylene groups, C₆-C₂₀ arylene groups, said arylene groups optionally being substituted with C₁-C₈ alkyl groups;

R₅ and R₇, which may be identical or different, are chosen from hydrogen, C₁-C₁₈ alkyl groups; or, when R₅ and R₇ are other than hydrogen, they may form, together with the nitrogen atoms to which they are attached, 5- or 6-membered heterocyclic rings;

R₆ is chosen from C₁-C₁₈ alkylene groups, C₆-C₁₄ arylene groups, arylene groups optionally substituted with C₁-C₁₈ alkyl groups, C₇-C₃₀ alkylenearylene or arylenealkylene groups, C₃-C₃₀ cycloalkylene groups, said cycloalkylene groups optionally being substituted with C₁-C₁₈ alkyl groups;

n is a integer from 0 to 5.

Preferably, R₁, R₂ and R₃ are C₁-C₃ alkoxy groups, R₄ is a C₁-C₃ alkylene group, R₇ is hydrogen and n is 0.

The abovementioned aminosilanes may be pure products or a mixture of different aminosilanes of formula (II).

Specific examples of aminosilanes of formula (II) are: 2-trimethoxysilylethylamine, 2-triethoxysilylethyl-amine, 2-tripropoxysilylethylamine, 2-tributoxysilyl-ethylamine, 3-trimethoxysilylpropylamine, 3-triethoxy-silylpropylamine, 3-tripropoxysilylpropylamine, 3-tri-isopropoxysilylpropylamine, 3-tributoxysilylpropyl-amine, 4-trimethoxysilylbutylamine, 4-triethoxysilyl-butylamine, 4-tripropoxysilylbutylamine, 4-tributoxy-silylbutylamine, 5-trimethoxysilylpentylamine, 5-tri-ethoxysilylpentylamine, 5-tripropoxysilylpentylamine, 5-tributoxysilylpentylamine, 6-trimethoxysilylhexyl-amine, 6-triethoxysilylhexylamine, 6-tripropoxysilyl-hexylamine, 6-tributoxysilylhexylamine, 7-trimethoxy-silylheptylamine, 7-triethoxysilylheptylamine, 7-tri-propoxysilylheptylamine, 7-tributoxysilylheptylamine, 8-trimethoxysilyloctylamine, 8-triethoxysilyloctyl-amine, 8-tripropoxysilyloctylamine, 8-tributoxysilyl-octylamine, N-(2-aminoethyl)-3-aminopropylmethyl-dimethoxysilane, N-(2-aminoethyl)-3-aminopropyl-trimethoxysilane, 1-[3-(trimethoxysilyl)propyl]-piperazine, N-[3-(trimethoxysilyl)propyl]-1,4-bis-(3-aminopropyl)piperazine, N-(3-aminopropyl)-3-amino-propyltrimethoxysilane, N-(4-aminobutyl)-3-aminopropyl-trimethoxysilane, N-[3-(trimethoxysilyl)propyl]-1,3-bis(aminomethyl)cyclohexane, N-[3-(trimethoxy-silyl)propyl]-4,4′-diaminodiphenylmethane, N-[3-(tri-methoxysilyl)propyl]-1,2-diaminocyclohexane, N-[3-(tri-methoxysilyl)propyl]-1,4-diaminobutane, N-[3-(tri-methoxysilyl)propyl]-2,4-diaminotoluene, N-(2-amino-ethyl)-N′-[3-(trimethoxysilyl)propyl)-1,3-propane-diamine, N-[2-[[3-(trimethoxysilyl)propyl]amino]ethyl]-1,3-propanediamine, N-(3-aminopropyl)-N′-[3-[[3-(tri-methoxysilyl)propyl]amino]propyl]-1,2-ethanediamine, N-(2-aminoethyl)-N′-[2-[[3-(trimethoxysilyl)propyl]-aminolethyl]-1,3-propanediamine, N-(3-aminopropyl)-N′-[3-[[3-(trimethoxysilyl)propyl]amino]propyl]-1,2-butanediamine, and the like. 3-Triethoxysilyl-propylamine is particularly preferred according to the present invention. An example of an aminosilane which may be used in the present invention and which is currently commercially available is the product Dynasylan® AMEO (A-1100) from Sivento-Chemie.

According to another preferred embodiment, the silane containing at least one hydrolysable group and at least one reactive group which is capable of reacting with said functional group of the elastomer is chosen from epoxysilanes such as, for example, 3-glycidyl-oxypropyltrimethoxysilane, 3-glycidyloxypropylmethyl-dimethoxysilane, 2-(3,4-epoxycyclohexyl)ethyltri-methoxysilane, and the like. 3-Glycidyloxypropyl-trimethoxysilane is preferred according to the present invention. An example of an epoxy silane which may be used in the present invention and which is currently commercially available is the product Dynasylan® GLYMO (A-187) from Sivento-Chemie.

As mentioned above, the coating layer may also comprise a butyl rubber. According to a preferred embodiment, the butyl rubber is chosen from copolymers containing from about 95.5% to about 99.5% isobutylene and from about 0.5% to about 4.5% isoprene.

As mentioned above, the coating layer may also comprise a diene elastomer. According to a preferred embodiment, the diene elastomer is chosen from natural and synthetic rubbers, optionally oil-extended, such as, for example, natural rubber; polybutadiene; poly-isoprene; styrene/butadiene copolymers; butadiene/iso-prene copolymers; styrene/isoprene copolymers; nitrile rubbers; terpolymers of ethylene, propylene and, for example, unconjugated dienes such as 5-ethylidene-2-norbornene, 1,4-hexadiene, cyclooctadiene or dicyclopentadiene; and the like, or mixtures thereof.

Natural rubber is particularly preferred according to the present invention.

For the purpose of further promoting the co-crosslinking with the other layers made of elastomeric material in the tyre, the coating layer, as mentioned above, may also comprise a coupling agent containing at least one hydrolysable silane group and at least one sulphur atom.

According to a preferred embodiment, the coupling agent is a compound of formula (III):

Z-Alk-Sₙ-Alk-Z (III)

in which Z is chosen from the following groups: —Si(R₁)₂(R₂), —Si(R₁)(R₂)₂ and —Si(R₂)₃, in which R₁ is a C₁-C₄ alkyl group, a cyclohexyl group or a phenyl group and R₂ is a C₁-C₁₈ alkoxy group or a C₅-C₈ cycloalkoxy group; Alk is a divalent hydrocarbon containing from 1 to 18 carbon atoms and n is a number from 2 to 8.

Specific examples of compounds of formula (III) are: 3,3′-bis(trimethoxysilylpropyl) disulphide, 3,3′-bis-(triethoxysilylpropyl)tetrasulphide, 3,3′-bis(tri-ethoxysilylpropyl)octasulphide, 3,3′-bis(trimethoxy-silylpropyl)tetrasulphide, 2,2′-bis(triethoxy-silylethyl)tetrasulphide, 3,3′-bis(trimethoxysilyl-propyl)trisulphide, 3,3′-bis(triethoxysilylpropyl)trisulphide, 3,3′-bis(tributoxysilylpropyl)disulphide, 3,3′-bis(trimethoxysilylpropyl)hexasulphide, 3,3′-bis-(trimethoxysilylpropyl)octasulphide, 3,3′-bis(tri-octoxysilylpropyl)tetrasulphide, 3,3′-bis(triethoxy-silylpropyl)disulphide, 3,3′-bis(tri-2-ethylhexoxy-silylpropyl)trisulphide, 3,3′-bis(triisooctoxysilyl-propyl)tetrasulphide, 3,3′-bis(tri-t-butoxysilyl-propyl)disulphide, 2,2′-bis(methoxydiethoxysilylethyl)tetrasulphide, 2,2′-bis(tripropoxysilylethyl)penta-sulphide, 3,3′-bis(tricyclohexoxysilylpropyl)tetra-sulphide, 3,3′-bis(tricyclopentoxysilylpropyl)tri-sulphide, 2,2′-bis(tri-2-methylcyclohexoxysilylethyl)tetrasulphide, bis(trimethoxysilylmethyl)tetra-sulphide, 3-methoxyethoxypropoxysilyl-3′-diethoxy-butoxysilylpropyl tetrasulphide, 2,2′-bis(dimethyl-methoxysilylethyl)disulphide, 2,2′-bis(dimethyl-S-butoxysilylethyl)trisulphide, 3,3′-bis(methylbutyl-ethoxysilylpropyl)tetrasulphide, 3,3′-bis(di-t-butylmethoxysilylpropyl)tetrasulphide; 2,2′-bis-(phenylmethylmethoxysilylethyl)trisulphide, 3,3′-bis-(diphenylisopropoxysilylpropyl)tetrasulphide, 3,3′-bis(diphenylcyclohexoxysilylpropyl)disulphide, 3,3′-bis(dimethylethylmercaptosilylpropyl)tetra-sulphide, 2,2′-bis(methyldimethoxysilylethyl)tri-sulphide, 2,2′-bis(methylethoxypropoxysilylethyl)tetrasulphide, 3,3′-bis(diethylmethoxysilylpropyl)tetrasulphide, 3,3′-bis(ethyldi-S-butoxysilylpropyl)disulphide, 3,3′-bis(propyldiethoxysilylpropyl)disulphide, 3,3′-bis(butyldimethoxysilylpropyl)trisulphide, 3,3′-bis(phenyldimethoxysilylpropyl)tetrasulphide, 3-phenylethoxybutoxysilyl-3′-trimethoxy-silylpropyl tetrasulphide, 4,4′-bis(trimethoxysilyl-butyl) tetrasulphide, 6,6′-bis(triethoxysilylhexyl)tetrasulphide, 12,12′-bis(triisopropoxysilyldodecyl)disulphide, 18,18′-bis(trimethoxysilyloctadecyl)tetrasulphide, 18,18′-bis(tripropoxysilyloctadecenyl)tetrasulphide, 4,4′-bis(trimethoxysilylbuten-2-yl)tetrasulphide, 4,4′-bis(trimethoxysilylcyclohexylene)tetrasulphide, 5,5′-bis(dimethoxymethylsilylpentyl)trisulphide, 3,3′-bis(trimethoxysilyl-2-methylpropyl)tetrasulphide, 3,3′-bis(dimethoxyphenylsilyl-2-methyl-propyl)disulphide. 3,3′-Bis(triethoxysilylpropyl)tetrasulphide is preferred according to the present invention. An example of a coupling agent which may be used in the present invention and which is currently commercially available is the product X50S® from Degussa.

For the purpose of increasing the rate and degree of crosslinking, the coating layer, as mentioned above, may also comprise a condensation catalyst.

According to a preferred embodiment, the condensation catalyst is chosen from:

carboxylates of metals such as tin, zinc, zirconium, iron, lead, cobalt, barium, calcium and manganese, and the like, such as, for example, dibutyltin dilaurate, dibutyltin diacetate, dioctyltin dilaurate, stannous acetate, stannous caprylate, lead naphthenate, zinc caprylate, zinc naphthenate, cobalt naphthenate, iron octanoate and iron 2-ethylhexanoate, and the like;

arylsulphonic acids or derivatives thereof such as, for example: toluenesulphonic acid, p-dodecyl-benzenesulphonic acid; tetrapropylbenzenesulphonic acid, acetyl p-dodecylbenzenesulphonate, 1-naphthalenesulphonic acid, 2-naphthalene-sulphonic acid, acetylmethyl sulphonate and acetyl p-toluenesulphonate, and the like;

amines and alkanolamines such as, for example, ethylamine, dibutylamine, hexylamine, pyridine and dimethylethanolamine, and the like;

strong inorganic acids or bases such as, for example, sodium hydroxide, potassium hydroxide, sulphuric acid or hydrochloric acid, and the like;

organic acids such as, for example, acetic acid, stearic acid or maleic acid, and the like;

blocked acids such as, for example, stearic anhydride or benzoic anhydride, and the like;

zeolites modified by reaction with -at least one carboxylic and/or sulphonic acid such as, for example, toluenesulphonic acid or α,β-naphthalene-sulphonic acid, and the like.

For the purpose of controlling the viscosity of the crosslinkable elastomeric material according to the present invention by avoiding premature coupling reactions between the hydrolysable silane groups present on the elastomer, the coating layer, as mentioned above, may also comprise a silane of general formula (I). Specific examples of silanes of general formula (I) are: methyltriethoxysilane, n-butyl-triethoxysilane, octyltriethoxysilane, triethylmethoxy-silane, diphenyldimethoxysilane and dicyclohexyl-diethoxysilane, and the like.

As already mentioned above, when an elastomer functionalized with at least one halogen group is used, said coating layer may also comprise a trapping agent capable of capturing the halohydric acid formed during the silanization reaction.

According to a preferred embodiment, the trapping agent is chosen from: magnesium oxide; tertiary amines such as, for example, triethylamine or N,N′-diisopropyl-ethylamine. Magnesium oxide is particularly preferred according to the present invention.

In addition, as mentioned above, the coating layer may comprise a crosslinking agent based on sulphur or derivatives thereof which is commonly used for curing diene elastomers. To this end, in the compounds, after a first step of thermomechanical processing, a crosslinking agent based on sulphur or derivatives thereof is incorporated together with vulcanization accelerators and activators. In this second step of processing, the temperature is generally kept below 12° C., preferably below 100° C., so as to avoid undesired scorching phenomena.

The curing agent most commonly used is sulphur, or molecules containing sulphur (sulphur donors).

Activators that are particularly effective are zinc compounds, and in particular ZnO, ZnCO₃, zinc salts of saturated or unsaturated fatty acids containing from 8 to 18 carbon atoms such as, for example, zinc stearate, preferably formed in situ in the compound from ZnO and fatty acid, and also BiO, PbO, Pb₃O₄ and PbO₂, and mixtures thereof.

Accelerators that are commonly used may be chosen from: dithiocarbamates, guanidine, thiourea, thiazoles, sulphenamides, thiurams, amines and xanthates, and the like, or mixtures thereof.

Said coating layer may also comprise reinforcing fillers (for example carbon black, silica, alumina, aluminosilicates, calcium carbonate or kaolin, and the like, or mixtures thereof), antioxidants, anti-ageing agents, protective agents, plasticizers, compatibilizers for the reinforcing filler, adhesives, anti-ozone agents, modifying resins, fibres (for example Kevlar® pulp) and lubricants (for example mineral oils, vegetable oils or synthetic oils, and the like, or mixtures thereof).

The abovementioned coating layer may be prepared by mixing the polymer components with the reinforcing filler optionally present and with the other additives according to techniques known in the art. The mixing may be carried out, for example, using an open-mill mixer or an internal mixer of the type with tangential rotors (Banbury) or interlocking rotors (Intermix), or in continuous mixers of the Ko-Kneader type (Buss) or co-rotating or counter-rotating twin-screw type. The compounds according to the present invention are preferably produced in two steps. In the first step, the mixture of the various ingredients apart from the vulcanization accelerator, the condensation catalyst and the curing agent is prepared. In the second step, the remaining ingredients are added to the mixture thus obtained.

The present invention will now be further illustrated by means of a number of production examples, with reference to the attached figures, which are given purely as a guide and therefore without limitation, in which:

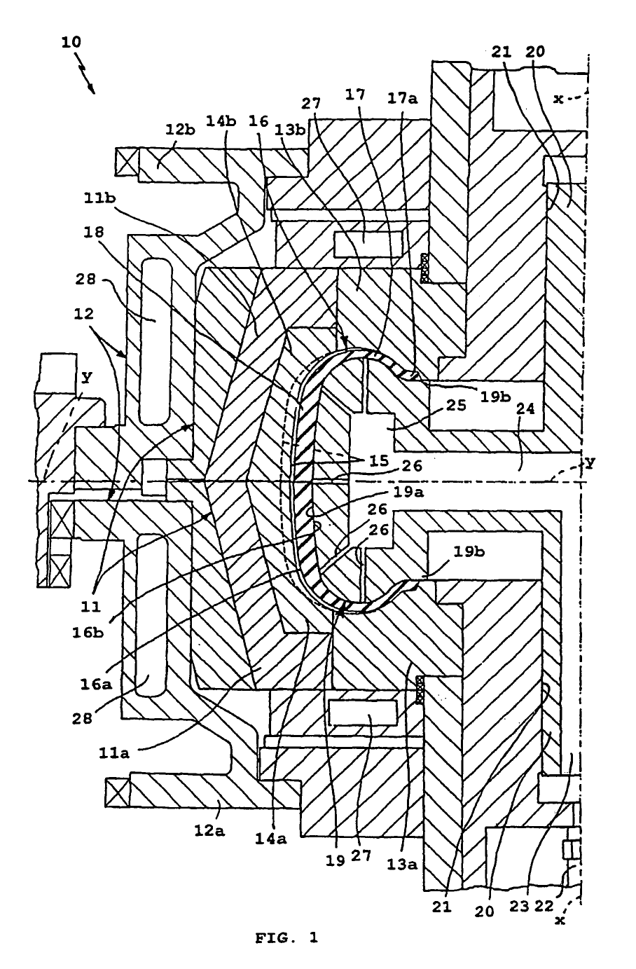

FIG. 1 shows, in cross section, a tyre enclosed inside a vulcanization mould;

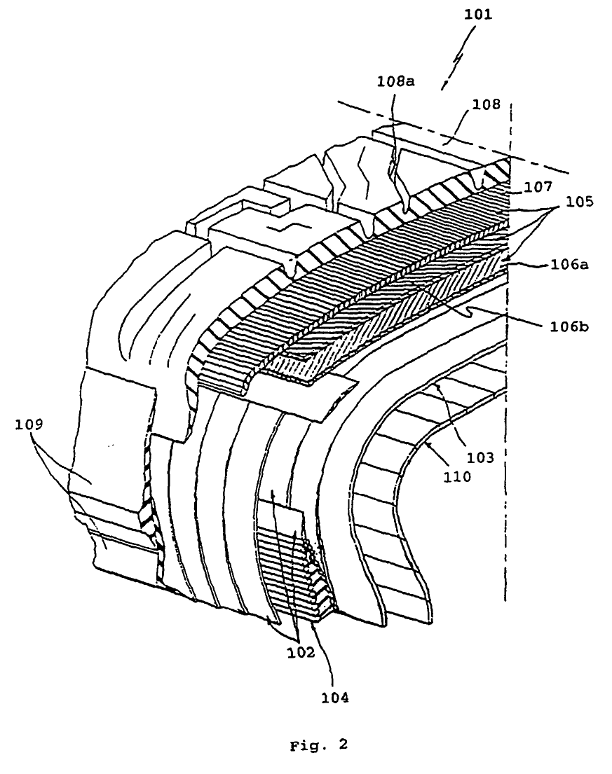

FIG. 2 is a partial cutaway perspective view of a tyre produced according to the invention.

### With reference to FIG. 1, (10) is a general reference for a moulding and vulcanization device for tyres of vehicle wheels.

The device (10) comprises a vulcanization mould (11) combined with a vulcanization press (12), said vulcanization press only being illustrated diagrammatically since it can be produced in any manner which is convenient to a person skilled in the art. For example, the mould (11) may be composed of a lower mould half (11a) and an upper mould half (11b) in engagement with a bed (12a) and a closing portion (12b) of press (12), respectively.

In the example illustrated for indicative purposes, each of the lower (11a) and upper (11b) mould halves of the mould (11) has a lower (13a) and upper (13b) cheek respectively, and a crown of lower (14a) and upper (14b) sectors.

The lower (11a) and upper (11b) mould halves are movable relative to each other between an open condition in which they are mutually spaced apart (not shown in FIG. 1), and a closed position, as shown in FIG. 1, in which they are disposed mutually closed to each other to form a moulding cavity (15) whose inner sides, defined by cheeks (12a) and (12b) and sectors (14a) and (14b), reproduce the geometric configuration of the outer surface (16a) of a tyre (16) to be obtained.

In more detail, cheeks (13a) and (13b) are intended to form the outer surfaces of the opposite sidewalls (17) of the tyre (16), while sectors (14a) and (14b) are intended to form the so-called tread band (18) of the tyre itself, creating a series of cuts and longitudinal and/or transverse notches and grooves therein, appropriately arranged in a “tread pattern”.

The device (10) also includes the use of at least one toroidal support (19) made of metal or another solid material, having an outer surface which substantially reproduces the shape of an inner surface of the tyre (16). The toroidal support (19) conveniently consists of a collapsible drum, that is to say that it is composed of centripetally mobile circumferential segments to disassemble the toroidal support and allow it to be removed easily from the tyre (16) once processing is complete.

In accordance with the present invention, the green tyre (16) is assembled on the toroidal support (19) before this support is inserted, together with the tyre itself, into the vulcanization mould (11) set in the open position. In particular, according to the present invention, a first layer of crosslinkable elastomeric material comprising at least one elastomer containing hydrolysable silane groups corresponding to the inner surface (16b) of the tyre (16) is formed on the toroidal support (19) on which the subsequent components are then formed. This forming step is advantageously carried out by winding at least one ribbon-like band, made of said crosslinkable elastomeric material comprising at least one elastomer containing hydrolysable silane groups, in close coils along the profile in cross section of the toroidal support. Said ribbon-like band may be obtained, for example, by extruding the abovementioned elastomeric material. In this way, the toroidal support (19) is advantageously used as a rigid mould for the forming and/or deposition of the various components such as, for example, the carcass plies, bead reinforcing structures, belt strips, sidewalls and tread band, involved in the formation of the tyre itself. Further details on the modalities of forming and/or deposition of the components of the tyre (16) on the toroidal support (19) are disclosed, for example, in the abovementioned patent applications EP-A-0 943 421 and EP-A-0 919 406 in the name of the Applicant.

In this case, the geometric configuration of the inner surface of the green tyre (16) will correspond exactly to the configuration of the outer surface of the toroidal support (19).

However, as will emerge more clearly hereinbelow, it is preferably provided that the extension of the outer surface (19a) of the toroidal support (19) should be adequately smaller than the extension of the inner surface (16b) of the tyre (16) once vulcanization is complete.

The toroidal support (19) preferably has at least one centering shank (20) to be engaged in a centering seat (21) provided in the mould (11), for establishing a precise positioning of the toroidal support (19) itself and of the tyre (16) carried thereon within the moulding cavity (15). In the production solution illustrated, the toroidal support (19) has two centering shanks (20) extending from opposite sides according to a geometric axis (x) common to the toroidal support (19), the tyre (16) and the moulding cavity (15) and arranged for being fitted into corresponding centering seats (21) formed in the bed (12a) and the closing portion (12b) of the vulcanization press (12), respectively.

More particularly, the coupling between each centering shank (20) of the toroidal support (19) and the corresponding centering seat (21) formed in the mould (11) defines, between each cheek (13a) and (13b) of the mould itself and the corresponding inner circumferential edge (19b) of the toroidal support (19), a housing seat for a radially internal edge (17a) of the tyre (16), usually known as the tyre “bead”. Said bead seats ensure precise geometric moulding of the beads (17a) since the geometry is determined by the direct coupling between the rigid surfaces of the toroidal support (19) and of the cheeks (13a) and (13b) of the mould (11).

In addition, the abovementioned bead seats ensure stable and precise centering of the tyre (16) relative to the axis (y) of the moulding cavity (15).

Preferably, the toroidal support (19) is also designed so as to have, at least at the regions corresponding to the beads (17a) of the tyre (16), an elastically yielding structure in an axial direction, following the mutual approaching of the cheeks (13a) and (13b) during the closing step of the mould (11).

The axial deformation which the toroidal support (19) undergoes in the zones of contact with the cheeks (13a) and (13b) in the vicinity of the beads (17a) of the tyre is preferably comprised between 0.3 mm and 0.5 mm, so as to generate on the surfaces in contact with the corresponding cheeks (13a) and (13b) a specific pressure comprised between 18 bar and 25 bar. Said contact pressure, during the step of moulding and curing the tyre (16), prevents any escape of elastomeric material between the surfaces in mutual contact of the toroidal support (19) and of the cheeks (13a) and (13b), thus avoiding the consequent formation of flash.

Once the positioning of the toroidal support (19) with the tyre (16) on the lower portion (11a) of the mould (11) has been carried out, the mould itself is placed in the closed position.

As may be seen in FIG. 1, when the mould (11) is closed, the walls of the moulding cavity (15) remain at a certain distance from the outer surface of the tyre (16), particularly in the tread band (18) of the latter. In this step, the tread band (18) may, however, be partially penetrated by reliefs located on the sectors (14a) and (14b) to define the abovementioned tread pattern.

Still on closure of the mould (11), each of the inner circumferential edges (17a) of the tyre (16) is sealingly engaged between the inner circumferential portions of the toroidal support (19) and inner circumferential portions of the lower (13a) and upper (13b) cheeks. The tyre (16) will remain sealingly engaged in the mould (11) in the manner described above until the moment at which, at the end of the moulding and curing cycle, the mould (11) itself will be brought again to its open position.

Once the mould closure has been completed (11), the tyre (16) is submitted to a pressing step with its outer surface (16a) against the walls of the moulding cavity (15), concomitant with the application of heat, so as to cause molecular crosslinking of the tyre itself and consequent geometrical and structural stabilization of the latter.

To this end, the device (10) is provided with pressing means comprising at least one primary duct (22) for feeding of a fluid under pressure, formed in bed (12a) of the press (11) for example, and opening into one of the centering seats (21) for sending a fluid under pressure to at least one connecting duct (23) made, preferably coaxially, along at least one of the centering shanks (20).

The connecting duct (23) terminates, for example through suitable branches (24) made radially in the toroidal support (19), at an annular chamber (25) present inside the toroidal support (19) itself. From the annular chamber (25) extends, through the toroidal support (19), a plurality of channels for feeding of fluid under pressure (26) which open into the outer surface (19a) of the toroidal support (19) itself and suitably distributed over the circumferential extension of said support.

The fluid under pressure fed from the primary duct (22) reaches the feeding channels (26) via the connecting duct (23), the radial branches (24) and the annular chamber (25), then opening onto the outer surface (19a) of the toroidal support (19). The fluid under pressure is thus introduced into a diffusion interspace created between the outer surface (19) of the toroidal support and the inner surface (16b) of the tyre (16) in which the feeding channels come together. Said inner surface (16b), as already mentioned above, consists of a layer of crosslinkable elastomeric material comprising at least one elastomer containing hydrolysable silane groups capable of crosslinking within the first moments of introduction of said fluid under pressure, and of thereby avoiding the diffusion of the fluid into the green tyre (16).

According to one embodiment of the present invention, the abovementioned diffusion interspace may be created directly as a result of an expansion of the tyre (16) brought about under the effect of the force exerted by the fluid under pressure. In other words, the pressing of the tyre (16) against the walls of the moulding cavity (15) takes place concomitantly with an expansion imposed on the tyre (16) itself, until its outer surface (16a) is brought to completely adhere to the inner walls of the moulding cavity (15).

Alternatively, according to another embodiment, the abovementioned diffusion interspace may be at least partially defined by a surface lowering provided on the outer surface (19a) of the toroidal support (19). In this case also, an expansion of the tyre (16) may be obtained concomitantly with the pressing step following from introduction of the fluid under pressure, which increases the volume of the diffusion interspace.

According to a preferred embodiment, the fluid under pressure introduced into the diffusion interspace consists of steam, said steam optionally being mixed with nitrogen or another inert gas.

A heating fluid may advantageously be introduced into said diffusion interspace so as to supply heat to the toroidal support (19) from the inside outwards. Said heating fluid may consist of or at least comprise the same fluid under pressure. In this case, the steam may be, preferably, overheated to a temperature preferably comprised between 170° C. and 210° C. and fed in at a pressure gradually increasing up to a value comprised between 16 bar and 30 bar, preferably about 18 bar. Consequently, the abovementioned primary duct (22) and connecting duct (23), and also the radial branches (24), the annular chamber (25) and the feeding channels (26) together with further ducts (27) and (28) adjacent to the cheeks (13a) and (13b) and to the sectors (14a) and (14b) of the mould (17) supplied with pressurized steam at high temperature, also act as means for heating the walls of the mould (11) in order to supply to tyre (16), from the outside inwards, the heat required for the molecular crosslinking of the tyre itself.

With reference to FIG. 2, the tyre (100) essentially comprises a carcass structure (102) having at least a first rubberized carcass ply (103) shaped in a substantially toroidal configuration and engaged, by means of its opposite circumferential edges, to a pair of inextensible annular structures (104) commonly known as “bead wires” which, once the tyre is finished, are located in the zone usually referred to as the bead. The opposite lateral edges of the abovementioned carcass ply (103) are coupled with respective bead wires (104). Alternatively, coupling between the carcass ply (103) and the bead wires (104) may be achieved by folding back the opposite lateral edges of the carcass ply (103) around the bead wires (104), so as to form the abovementioned carcass back-folds (not shown in FIG. 2).

The rubberized carcass ply (103) generally consists of a plurality of reinforcing cords arranged parallel to each other and at least partially coated with a layer of elastomeric compound. These reinforcing cords usually consist of steel wires which are stranded together, coated with a metal alloy (for example copper/zinc, zinc/manganese or zinc/molybdenum/cobalt alloys, and the like).

The rubberized carcass ply (103) is usually of radial type, i.e. it incorporates reinforcing cords arranged in a substantially perpendicular direction relative to a circumferential direction.

A belt structure (105) comprising one or more belt strips (106a), (106b) and (107) is applied to the carcass structure (102), in a circumferentially external position. In the specific embodiment of FIG. 2, the belt structure (105) comprises two belt strips (106a) and (106b), which incorporate a plurality of reinforcing cords, typically metal cords, parallel to each other in each strip and oblique with respect to the adjacent strip, oriented so as to form a predetermined angle with respect to a circumferential direction. The belt structure (105) may optionally comprise at least one reinforcing layer (107) at 0° commonly known as a “0° belt”, placed on the radially outermost belt strip (106b), which generally incorporates a plurality of reinforcing cords, typically textile cords, arranged at an angle of a few degrees with respect to a circumferential direction, coated and welded together by means of an elastomeric material.

A tread band (108) is superimposed circumferentially on the belt structure (105) and on it, after a moulding operation carried out concomitantly with the curing of the tyre, are made longitudinal and/or transverse grooves (108) arranged so as to define a desired “tread pattern”.

The tyre (100) also comprises a pair of sidewalls (109) applied laterally to the opposite sides of the carcass structure (102). A strip made of elastomeric material (not shown in FIG. 2) commonly known as a “mini-sidewall” may optionally be present in the connecting zone between the sidewalls (109) and the tread band (108), which is generally obtained by co-extrusion with the tread band and makes it possible to improve the mechanical interaction between the tread band (108) and the sidewalls (109).

In the case of tubeless tyres, a further coating layer (not shown in FIG. 2) may also be provided in a radially internal position with respect to the rubberized carcass ply (103), over the coating layer (110) according to the present invention. This further coating layer can further ensure impermeability to a fluid for inflating the tyre when this tyre is installed on a rim and inflated.

The present invention will be further illustrated hereinbelow with the aid of a number of production examples, given purely for indicative purposes and without any limitation thereof.

### EXAMPLES 1-8

The compounds given in Table 1 (phr) were prepared as follows.

All the components given in Table 1, except for ZnO, DBTL, sulphur and TBBS, were mixed together in an internal mixer (Pomini PL 1.6 model). AMEO, MgO, stearic acid and antioxidant were mixed together beforehand with carbon black before being introduced into the internal mixer. After about 5 minutes and, in any case, as soon as the temperature reached 125±5° C., the abovementioned compound was removed from the reactor (1st step).

Said compound was introduced into an open laboratory mixer and the missing components, i.e. ZnO, DBTL, sulphur and TBBS, were added (2nd step).

TABLE 1

| EXAMPLE | | | | | | | |
|---|---|---|---|---|---|---|---|
| 1 | 2 | 3 | 4 | 5 | 6 | 7 | 8 |

1^{ST} STEP

| | | | | | | | | |
|---|---|---|---|---|---|---|---|---|
| NR | 30 | 30 | 30 | 30 | 30 | 30 | 30 | 30 |
| CIIR | 70 | 70 | 70 | 70 | 70 | 70 | 70 | 70 |
| Carbon | 60 | 60 | 60 | 60 | 60 | 60 | 60 | 60 |
| black | | | | | | | | |
| Aromatic | 10 | 10 | 10 | 10 | 10 | 10 | 10 | 10 |
| oil | | | | | | | | |
| Stearic | 2 | 2 | 2 | 2 | 2 | 2 | 2 | 2 |
| acid | | | | | | | | |
| Antioxidant | 0.5 | 0.5 | 0.5 | 0.5 | 0.5 | 0.5 | 0.5 | 0.5 |
| Magnesium | — | 2 | 2 | 2 | 2 | 2 | 2 | 2 |
| oxide | | | | | | | | |
| Calcium | — | — | 3 | — | — | — | — | — |
| oxide | | | | | | | | |
| AMEO | — | 2 | 2 | 2 | 2 | 2 | 2 | 2 |
| TESPT | — | 1 | 1 | 1 | 0.5 | — | — | 1 |

2^{ND} STEP

| | | | | | | | | |
|---|---|---|---|---|---|---|---|---|
| ZnO | 3 | 3 | 3 | 3 | 3 | 3 | 3 | — |
| DBTL | — | 0.1 | 0.1 | — | 0.1 | 0.1 | — | 0.1 |
| TBBS | 0.7 | 0.7 | 0.7 | 0.7 | 0.7 | 0.7 | 0.7 | — |
| Sulphur | 1.3 | 1.3 | 1.3 | 1.3 | 1.3 | 1.3 | 1.3 | — |

NR: Natural rubber;
CIIR: Chlorinated isobutylene/isoprene copolymer with a halogen content of 1.2% by weight (Polysar ® Chlorobutyl 1240 from Bayer);
Carbon black: N660 (Cabot);
Antioxidant: Phenyl-p-phenylenediamine;
AMEO: 3-Aminopropyltriethoxysilane (Dynasylan ® AMEO (A-1100) from Sivento Chemie);
TESPT: 3,3′-bis(3-triethoxysilylpropyl) tetrasulphide (X50S comprising 50% carbon black and 50% silane, from Degussa - the amount given is relative to the amount of silano);
DBTL: Dibutyltin dilaurate;
TBBS: N-t-Butyl-2-benzothiazilesulphenamide (Vulkacit NZ from Bayer).

The compounds described above were subjected to MDR rheometric analysis using a Monsanto MDR rheometer, the tests being carried out at 135° C. for 30 minutes at an oscillation frequency of 1.66 Hz (100 oscillations per minute) and an oscillation amplitude of ±0.50.

The mechanical properties were measured in accordance with ISO 37 standard on samples obtained by curing the abovementioned compositions at 160° C. for 20 minutes, and the data obtained are given in Table 2.

TABLE 2

| EXAMPLE | | | | | | | |
|---|---|---|---|---|---|---|---|
| 1 | 2 | 3 | 4 | 5 | 6 | 7 | 8 |

MDR (30 min at 135° C.)

| | | | | | | | | |
|---|---|---|---|---|---|---|---|---|
| Δ torque | 7.57 | 7.32 | 7.30 | 6.58 | 6.83 | 6.09 | 6.46 | 1.02 |
| T05 | 4.19 | 0.93 | 1.05 | 1.02 | 0.90 | 0.86 | 1.41 | — |
| (min.) | | | | | | | | |
| TS1 | 8.67 | 1.54 | 1.77 | 1.84 | 1.49 | 1.47 | 2.16 | 27.9 |
| (min.) | | | | | | | | |
| T30 | 12.83 | 2.65 | 2.94 | 3.30 | 2.44 | 2.32 | 2.90 | — |
| (min.) | | | | | | | | |
| T60 | 17.15 | 7.10 | 7.46 | 9.24 | 6.59 | 6.58 | 5.34 | — |
| (min.) | | | | | | | | |

VULCANIZATION (20 min at 160° C.)

| | | | | | | | | |
|---|---|---|---|---|---|---|---|---|
| 100% | 2.64 | 2.24 | 1.79 | 1.95 | 2.22 | 1.96 | 2.03 | 0.73 |
| modulus | | | | | | | | |

### EXAMPLE 9

The compound of Example 2 was used to prepare the coating layer of some P6000 205/60R15 tyres. The tyres were manufactured using a device as shown in FIG. 1, using steam as fluid under pressure. After curing, the tyres were examined visually and no drawbacks were found such as, for example, the presence of bubbles or fissures either on the liner or on the carcass, or the presence of any bubbles visible from the outside in the region of the sidewalls and the “mini-sidewalls”, caused by permeation of the steam into the structure of the tyre.

1. Process for manufacturing, moulding and curing tyres for vehicle wheels, comprising the following steps:
forming at least one coating layer made of crosslinkable elastomeric material on an outer surface of a toroidal support the shape of which substantially matches that of the inner surface of the tyre;
manufacturing a green tyre comprising at least one element which includes a crosslinkable elastomeric material on said toroidal support bearing said coating layer;
closing the green tyre in a moulding cavity defined inside a vulcanization mould, said moulding cavity having walls the shape of which matches that of an outer surface of the tyre once vulcanization is complete;
introducing into the space defined by an inner surface of the tyre a fluid under pressure to press the outer surface of the green tyre against the walls of the moulding cavity;
applying heat to the tyre for causing the vulcanization of the crosslinkable elastomeric material;
characterized in that said coating layer comprises at least one elastomer containing hydrolysable silane groups.

2. Process according to claim 1, in which said coating layer comprises a crosslinking agent based on sulphur or derivatives thereof.

3. Process according to claim 1 or 2, in which the coating layer reaches a degree of crosslinking which is sufficient to prevent the diffusion and penetration of the fluid under pressure into the green tyre, within a period not greater than 10 minutes, working at a temperature not greater than 210° C.

4. Process according to claim 3, in which said coating layer reaches a degree of crosslinking which is sufficient to prevent the diffusion and penetration of the fluid under pressure into the green tyre within a period of between 1 minute and 5 minutes.

5. Process according to claim 3 or 4, in which the coating layer reaches a degree of crosslinking which is sufficient to prevent the diffusion and penetration of the fluid under pressure into the green tyre, working at a temperature of between 100° C. and 140° C.

6. Process according to any one of the preceding claims, in which the fluid under pressure is chosen from steam, air and nitrogen, or mixtures thereof.

7. Process according to claim 6, in which the fluid under pressure is steam.

8. Process according to any one of the preceding claims, in which the coating layer comprises from 20 phr to 100 phr of at least one elastomer containing hydrolysable silane groups.

9. Process according to claim 8, in which the coating layer comprises from 50 phr to 90 phr of at least one elastomer containing hydrolysable silane groups.

10. Process according to any one of the preceding claims, in which the elastomer containing hydrolysable silane groups comprises from 0.1% to 5% by weight of hydrolysable silane groups.

11. Process according to claim 10, in which the elastomer containing hydrolysable silane groups comprises from 0.5% to 3% by weight of hydrolysable silane groups.

12. Process according to any one of the preceding claims, in which the coating layer comprises from 0 phr to 30 phr of at least one butyl rubber.

13. Process according to claim 12, in which the coating layer comprises from 5 phr to 15 phr of at least one butyl rubber.

14. Process according to any one of the preceding claims, in which the coating layer comprises from 0 phr to 80 phr of at least one diene elastomer other than butyl rubber.

15. Process according to claim 14, in which the coating layer comprises from 10 phr to 50 phr of at least one diene elastomer other than butyl rubber.

16. Process according to any one of the preceding claims, in which the coating layer comprises from 0 phr to 3 phr of a coupling agent.

17. Process according to claim 16, in which the coating layer comprises from 0.5 phr to 1.5 phr of a coupling agent.

18. Process according to any one of the preceding claims, in which the coating layer comprises from 0 phr to 0.5 phr of a condensation catalyst.

19. Process according to claim 18, in which the coating layer comprises from 0.05 phr to 0.15 phr of a condensation catalyst.

20. Process according to any one of the preceding claims, in which the coating layer comprises from 0 phr to 5 phr of a silane of general formula (I): 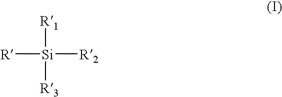
in which:
R′ is chosen from C₁-C₁₈ alkyl groups, C₆-C₂₀ aryl groups, C₇-C₃₀ alkylaryl or arylalkyl groups, C₃-C₃₀ cycloalkyl groups, said cycloalkyl groups optionally being substituted with C₁-C₁₈ alkyl groups;
R′₁, R′₂ and R′₃, which may be identical or different, are chosen from hydrogen, C₁-C₈ alkoxy groups, C₁-C₁₈ alkyl groups, C₆-C₂₀ aryl groups, C₇-C₃₀ alkylaryl or arylalkyl groups, on condition that at least one of the groups R′₁, R′₂ and R′₃ represents an alkoxy group.

21. Process according to claim 20, in which the coating layer comprises from 0.5 phr to 3 phr of a silane of general formula (I).

22. Process according to any one of the preceding claims, in which the elastomer containing hydrolysable silane groups is obtained by reacting an elastomer containing at least one functional group with a silane containing at least one hydrolysable group and at least one reactive group which is capable of reacting with said functional group of the elastomer.

23. Process according to claim 22, in which the elastomer containing at least one functional group is an elastomer containing at least one halogen functional group chosen from chlorine and bromine.

24. Process according to claim 22, in which the elastomer containing at least one functional group is an elastomer containing at least one functional group chosen from:
anhydride groups —(RCO)₂O in which R is an alkylene group;
carboxyl groups —COOH;
ester groups —COOR in which R is an alkyl or aryl group;
amide groups —CONH₂.

25. Process according to claim 23, in which the coating layer comprises from 0.1 phr to 4 phr of a trapping agent.

26. Process according to claim 25, in which the coating layer comprises from 1 phr to 3 phr of a trapping agent.

27. Process according to any one of claims 22 to 26, in which the reactive group of the silane is chosen from amine groups and epoxide groups.

28. Process according to any one of claims 22 to 27, in which the silane is used in an amount of between 0.1 phr and 5 phr.

29. Process according to claim 28, in which the silane is used in an amount of between 0.5 phr and 3 phr.

30. Process according to claim 23, in which the elastomer containing a halogen functional group is chosen from halobutyl rubbers, epihalohydrin rubbers and halogenated isobutylene/p-alkylstyrene copolymers.

31. Process according to any one of claims 22 to 30, in which the silane containing at least one hydrolysable group and at least one reactive group which is capable of reacting with the abovementioned functional groups is an aminosilane of general formula (II): 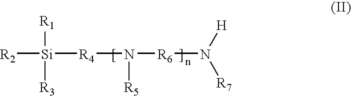
in which:
R₁, R₂ and R₃, which may be identical or different, are chosen from hydrogen, C₁-C₈ alkoxy groups, C₁-C₁₈ alkyl groups, C₆-C₂₀ aryl groups, C₇-C₃₀ alkylaryl or arylalkyl groups, on condition that at least one of the groups R₁, R₂ and R₃ represents an alkoxy group;
R₄ is chosen from C₁-C₁₈ alkylene groups, C₆-C₂₀ arylene groups, said arylene groups optionally being substituted with C₁-C₈ alkyl groups;
R₅ and R₇, which may be identical or different, are chosen from hydrogen, C₁-C₁₈ alkyl groups; or, when R₅ and R₇ are other than hydrogen, they may form, together with the nitrogen atoms to which they are attached, 5- or 6-membered heterocyclic rings;
R₆ is chosen from C₁-C₁₈ alkylene groups, C₆-C14 arylene groups, arylene groups optionally substituted with C₁-C₁₈ alkyl groups, C₇-C₃₀ alkylenearylene or arylenealkylene groups, C₃-C₃₀ cycloalkylene groups, said cycloalkylene groups optionally being substituted with C₁-C₁₈ alkyl groups;
n is a integer from 0 to 5.

32. Process according to claim 31, in which R₁, R₂ and R₃ are C₁-C₃ alkoxy groups, R₄ is a C₁-C₃ alkylene group, R₇ is hydrogen and n is 0.

33. Process according to any one of claims 22 to 30, in which the silane containing at least one reactive group which is capable of reacting with the abovementioned functional groups is an epoxy silane.

34. Process according to claim 33, in which the epoxy-silane is chosen from: 3-glycidyloxypropyltri-methoxysilane, 3-glycidyloxypropylmethyldimethoxy-silane and 2-(3,4-epoxycyclohexyl)ethyltrimethoxy-silane.

35. Process according to claim 12 or 13, in which the butyl rubber is chosen from copolymers containing from about 95.5% to about 99.5% isobutylene and from about 0.5% to about 4.5% isoprene.

36. Process according to claim 14 or 15, in which the diene elastomer is chosen from natural and synthetic rubbers, optionally oil-extended, such as natural rubber; polybutadiene; polyisoprene; styrene/butadiene copolymers; butadiene/isoprene copolymers; styrene/isoprene copolymers; nitrile rubbers; terpolymers of ethylene, propylene and unconjugated dienes such as 5-ethylidene-2-norbornene, 1,4-hexadiene, cyclooctadiene or dicyclopentadiene; or mixtures thereof.

37. Process according to claim 16 or 17, in which the coupling agent contains at least one hydrolysable silane group and at least one sulphur atom.

38. Process according to claim 37, in which the coupling agent is a compound of formula (III):
Z-Alk-Sₙ-Alk-Z (III)
in which Z is chosen from the following groups: —Si(R₁)₂(R₂), —Si(R₁)(R₂)₂ and —Si(R₂)₃, in which R₁ is a C₁-C₄ alkyl group, a cyclohexyl group or a phenyl group and R₂ is a C₁-C₁₈ alkoxy group or a C₅-C₈ cycloalkoxy group; Alk is a divalent hydrocarbon containing from 1 to 18 carbon atoms and n is a number from 2 to 8.

39. Process according to claim 18 or 19, in which the condensation catalyst is chosen from:
metal carboxylates;
arylsulphonic acids or derivatives thereof;
amines and alkanolamines;
strong inorganic acids or bases;
organic acids;
blocked acids;
zeolites modified by reaction with at least one carboxylic and/or sulphonic acid.

40. Process according to claim 25 or 26, in which the trapping agent is chosen from: magnesium oxide, tertiary amines such as triethylamine or N,N′-diisopropylethylamine.

41. Tyre for a vehicle wheel, comprising the following elements:
a carcass structure having at least one rubberized carcass ply shaped in a substantially toroidal configuration and engaged, by means of its opposite circumferential edges, to a pair of inextensible annular structures;
a belt structure comprising at least one belt strip applied in a circumferentially external position relative to said carcass structure;
a tread band circumferentially superimposed on said belt structure;
a pair of sidewalls applied laterally to opposite sides relative to said carcass structure;
a coating layer made of crosslinked elastomeric material placed in a radially internal position relative to said rubberized carcass ply;
characterized in that said coating layer is obtained by crosslinking at least one elastomer containing hydrolysable silane groups.

42. Tyre according to claim 41, in which the crosslinking of said coating layer is obtained in the presence of a crosslinking agent based on sulphur or derivatives thereof.

43. Tyre according to claim 41 or 42, in which the coating layer is defined in any one of claims 8 to 39.

44. Tyre according to any one of claims 41 to 43, in which the coating layer is the layer which is impermeable to a fluid for inflating the tyre when this tyre is installed on a wheel rim.
